(19) United States
(12) Patent Application Publication
(10) Pub. No.: US 2006/0235864 A1
(43) Pub. Date: Oct. 19, 2006

(54) Audio sampling and acquisition system

(75) Inventors: Steve Hotelling, San Jose, CA (US); Andrew Bert Hodge, Menlo Park, CA (US); Emily Clark Schubert, Los Altos, CA (US); Robert Edward Borchers, Pleasanton, CA (US); Jesse L. Dorogusker, Menlo Park, CA (US); Chris Bell, Pacifica, CA (US)

Correspondence Address: BEYER WEAVER & THOMAS, LLP, P.O. BOX 70250, OAKLAND, CA, 94612-0250, US

(73) Assignee: Apple Computer, Inc.

(21) Appl. No.: 11/210,172

(22) Filed: Aug. 22, 2005

Related U.S. Application Data
(60) Provisional application No. 60/672,160, filed on Apr. 14, 2005.

(51) Int. Cl. G06F 17/00

(52) U.S. Cl. 707/101

(57) ABSTRACT

Techniques for facilitating purchase of media items, such as digital media assets, are disclosed. A computing device, e.g., a portable media device, can save media indicia pertaining to one or media items of interest to a user. The media indicia can thereafter be use to purchase the one or more media items or other products associated therewith.

### CROSS-REFERENCE To RELATED APPLICATIONS

This application claims priority under 35 USC §119 to U.S. Provisional Patent Application No. 60/672,160, filed Apr. 14, 2005, and entitled “AUDIO SAMPLING AND ACQUISITION SYSTEM” [Atty Docket No. APL1P345P], which is hereby incorporated herein by reference.

This application is related to (i) U.S. patent application Ser. No. 10/832,812, filed Apr. 26, 2004, and entitled “METHOD AND SYSTEM FOR SECURE NETWORK-BASED DISTRIBUTION OF CONTENT” [Atty Docket No. APL1P269X1]; (ii) U.S. patent application Ser. No. 10/987,649, filed Nov. 12, 2004, and entitled “WIRELESS SYNCHRONIZATION BETWEEN MEDIA PLAYER AND HOST DEVICE” [Atty Docket No. APL1P320]; (iii) U.S. patent application Ser. No. 10/982,592, filed Nov. 5, 2004, and entitled “DIGITAL MEDIA FILE WITH EMBEDDED SALES/MARKETING INFORMATION” [Atty Docket No. APL1P338]; (iii) U.S. patent application Ser. No. 10/833,267, filed Apr. 26, 2004, and entitled “METHOD AND SYSTEM FOR NETWORK-BASED PURCHASE AND DISTRIBUTION OF MEDIA” [Atty Docket No. APL1P270X1]; (iv) U.S. patent application Ser. No. 10/982,592, filed Nov. 5, 2004, and entitled “DIGITAL MEDIA FILE WITH EMBEDDED SALES/MARKETING INFORMATION” [Atty Docket No. APL1P338]; (v) U.S. Provisional Patent Application No. 60/622,178, filed Oct. 25, 2004, and entitled “RESERVATION OF DIGITAL MEDIA ITEMS” [Atty Docket No. APL1P339P]; (vi), U.S. Provisional Patent Application No. 60/622,280, filed Oct. 25, 2004, and entitled “ONLINE PURCHASE OF DIGITAL MEDIA BUNDLES” [Atty Docket No. APL1P349P]; and (vii) U.S. Provisional Patent Application No. 60/620,223, filed Oct. 18, 2004, and entitled “NETWORK-BASED PURCHASE AND DISTRIBUTION OF DIGITAL MEDIA ITEMS” [Atty Docket No. APL1P353P], all of which are hereby incorporated by reference herein.

### BACKGROUND OF THE INVENTION

1. Field of the Invention

The present invention relates to media identification, purchase and distribution of media.

2. Description of the Related Art

Currently, there are several music identification services available for consumer use. Generally, these services fall into three categories. The first category identifies a song through use of a radio station's play list. For example, for a song of interest, a radio station frequency and a time of day would be captured, and then using the radio station's play list, the song can be identified. The second category identifies a song by analyzing a digital sample and is typically employed in anti-piracy efforts to ensure the accuracy of identification information attached to a digital music file. The third category identifies a song by analyzing an analog sample (e.g., recording an audio source using a microphone). Analog music identification is beginning to be used in cellular phone music identification services.

Typically, when a user wants to use an analog music identification service, that user dials the number for the music identification service into a mobile phone and lets the music identification service listen to a sample of the song. The music identification service then identifies the song and then informs the user which song was heard. Typically, the service sends a text (SMS) message with information about the song to the mobile phone. Additionally, the music identification service typically also stores the information sent to the mobile phone on-line, which the user may access through a web browser.

However, a mobile phone is often not the best device to use for analog music identification applications. Generally, wireless networks have limitations in service area and reliability issues. Moreover, wireless network airtime is typically expensive and special services such as music identification usually cost extra.

Alternately, some music identification services allow a user of an MP3 player to record a sample of a song being broadcast over the airwaves (i.e., FM radio). The recorded song sample can be later identified when it synchronizes with a client computer, which communicates with a music identification service to obtain artist name and song title.

Unfortunately, however, conventional music identification only provides minimal identification information about the music, such as artist and song title. Conventional music identification is also not always reliable in its identifications. Even when a song is able to be properly identified, there is no ability to provide additional services to users, such as the ability to purchase identified songs.

Thus, there is a need for music identification services that are not only more reliable but also provide e-commerce functionality.

### SUMMARY OF THE INVENTION

In general, the invention pertains to facilitating purchase of media items, such as digital media assets. For the benefit of a user, a computing device can acquire media item indicia pertaining to one or media items of interest. The media indicia can thereafter be use to purchase the one or more media items or other products associated therewith. Regardless of the product(s) purchased, the purchase process can be user friendly and substantially automated.

A first aspect of the invention pertains to techniques for identifying audio media recordings (e.g., songs) by a using portable media device. These techniques allow a user of a portable media device to identify, for instance, an audible song, by recording an audio sample using a microphone and later identifying the audio sample using media identification technology. Alternately, an audio sample may be obtained by tuning to a wireless signal. In any event, the audio sample can be identified using some form of audio or song recognition program, typically at a server computer to which the audio sample has been uploaded. Once the audio sample has been identified, the user can be given the option to purchase one or more digital media assets associated with the identified audio sample.

Digital media assets available for purchase and download can include a variety of media file types, including audio (e.g., MP3, MP4, MC, WAV, etc.), video (AVI, Quicktime™, etc.), electronic book (eBook), as well as others. Digital media assets can include music singles and music videos, for example. Additionally, ring tones and graphics associated with the digital media asset can also be purchased.

Another aspect of the invention pertains to a media tagging and acquisition system. As explained in more detail below, a portable media player can be coupled to a media system within a vehicle or other environment such that one or more digital media assets being presented by the media system can be tagged (flagged). After a digital media asset has been tagged, the portable media player can be removed from the vehicle or other environment and coupled to an electronic commerce environment. The electronic commerce environment facilitates the purchase of the digital asset that has been tagged.

The invention can be implemented in numerous ways, including as a method, system, device, apparatus, or computer readable medium. Several embodiments of the invention are discussed below.

As a method for facilitating e-commerce, one embodiment of the invention includes at least the acts of: recording an audio sample using a portable media device; subsequently transferring the audio sample from the portable media device to a networked client device; identifying one or more media assets associated with the audio sample; and obtaining the purchased media assets at the networked client device. Media assets can include various media types, such as music singles or albums, music videos, motion pictures and electronic books (e-books).

As a method for facilitating e-commerce, another embodiment of the invention includes at least the acts of: receiving, at a server computer, an audio sample from a client computer; identifying at least one media asset associated with the audio sample; receiving a request to purchase the identified media asset, processing a payment for the identified media asset; and delivering the one or more identified media assets to the client computer.

As a method for facilitating e-commerce, still another embodiment of the invention includes at least the acts of: recording an audio sample using a portable media player; transferring the audio sample from the portable media player to a networked client device; receiving, from the networked client device, media information identifying one or more media assets associated with the audio sample; purchasing, at the networked client device, the one or more media assets identified by the media information; and obtaining, at the networked client device, the media assets that have been purchased.

As a method for facilitating e-commerce, yet still another embodiment of the invention includes at least the acts of: recording an audio sample using a portable media device; identifying one or more media assets associated with the audio sample; and obtaining, at the portable media device, the one or more identified media assets.

As a computer readable medium including at least computer program code for facilitating e-commerce, one embodiment of the invention includes at least: computer program code for storing a media indicia at a portable media device, the media indicia being associated with a digital media asset of interest to a user of the portable media device; computer program code for subsequently transferring the media indicia from the portable media device to a networked client device; computer program code for identifying at least one digital media asset associated with the audio sample based on the media indicia; and computer program code for obtaining, at the networked client device, the at least one identified digital media assets from a remote server via a network.

As a method for facilitating on-line purchase of media related items, one embodiment of the invention includes at least the acts of: coupling a portable media device to an in-vehicle network having an in-vehicle media receiver-player coupled thereto; outputting media using the in-vehicle media receiver-player; querying the in-vehicle network for descriptive media information pertaining to the media being output; and storing the descriptive media information at the portable media device.

As a method for facilitating on-line purchase of products, one embodiment of the invention includes at least the acts of: perceiving, by a user, information about a product; interacting with a portable media device to signal an interest in the product; capturing digital data associated with the product using a wireless receiver, the digital data being receivable at the vicinity of where the user perceived the product; and subsequently forwarding the digital data to an electronic commerce engine to facilitate purchase of the product or a related product.

As a method for facilitating on-line purchase of products, another embodiment of the invention includes at least the acts of: receiving, at a portable media device, a signal from a user indicating an interest in a product being perceived by the user; capturing digital data associated with the product using a wireless receiver, the digital data being receivable at the vicinity of where the user perceived the product; and subsequently forwarding the digital data to an electronic commerce engine to facilitate purchase of the product or a related product.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a media purchase system according to one embodiment of the invention.

FIG. 2 is a flow diagram of an audio sample identification and purchase process according to one embodiment of the invention.

FIG. 3 is a diagram of an application program window according to one embodiment of the invention.

FIG. 4A is a flow diagram of a basic media identification process according to one embodiment of the invention.

FIG. 4B is a flow diagram of a server side media identification and purchase process according to one embodiment of the invention.

FIG. 5A is a block diagram of an audio sampling process according to one embodiment of the invention.

FIG. 5B is a block diagram of a client-side audio sample identification and purchase process according to one embodiment of the invention.

FIG. 6 shows an exemplary portable media device suitable for use with the invention.

FIG. 7A is a block diagram of a media tagging and acquisition system according to one embodiment of the invention.

FIG. 7B is a block diagram of a media tagging and acquisition system according to another embodiment of the invention.

FIG. 8 is a media tagging process according to one embodiment of the invention.

FIG. 9 is a flow diagram of a media content tagging process according to another embodiment of the invention.

FIG. 10 is a flow diagram of a media information transfer process according to one embodiment of the invention.

FIGS. 11A and 11B are flow diagrams of a purchase process according to one embodiment of the invention.

FIG. 12 shows an exemplary computer system suitable for use with the invention.

### DETAILED DESCRIPTION OF THE INVENTION

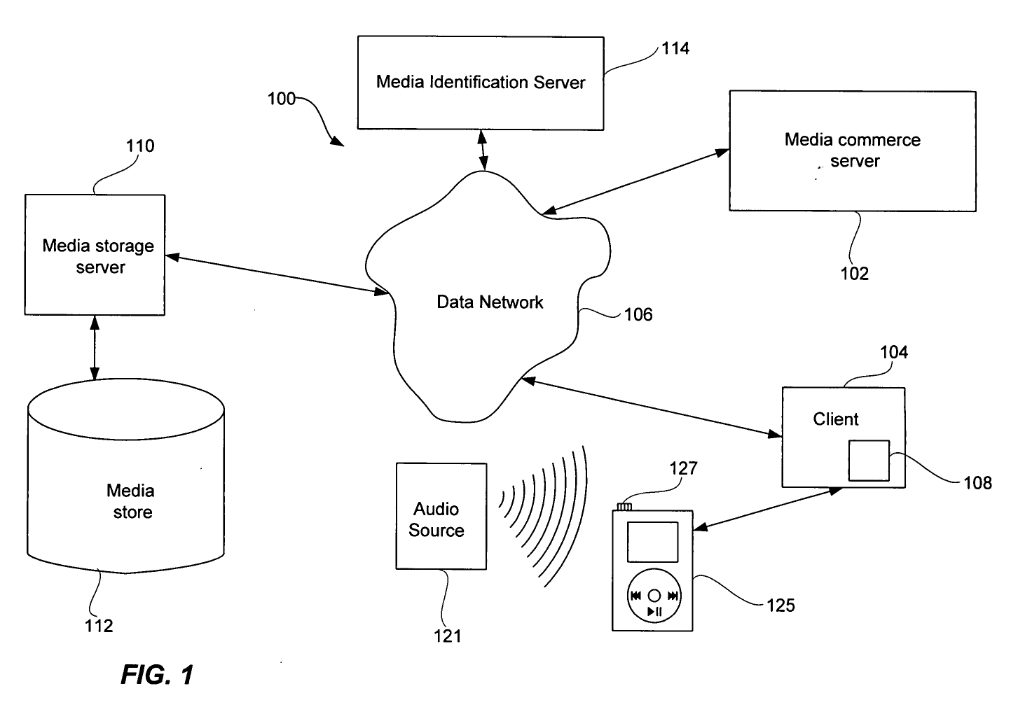

Embodiments of the invention are discussed below with reference to FIGS. 1-12. However, those skilled in the art will readily appreciate that the detailed description given herein is for explanatory purposes as the invention extends beyond these limited embodiments.

One aspect of the invention pertains to techniques for identifying audio media recordings (e.g., songs) by a using portable media device. These techniques allow a user of a portable media device to identify, for instance, an audible song, by recording an audio sample using a microphone and later identifying the audio sample using media identification technology. Alternately, an audio sample may be obtained by tuning into a wireless signal. In any event, the audio sample can be identified using some form of audio or song recognition program, typically at a server computer to which the audio sample has been uploaded. Once the audio sample has been identified, the user can be given the option to purchase one or more digital media assets associated with the identified audio sample.

Digital media assets available for purchase and download can include a variety of media file types, including audio (e.g., MP3, MP4, MC, WAV, etc.), video (AVI, Quicktime™, etc.), electronic book (eBook), as well as others. Digital media assets can include music singles and music videos, for example. Additionally, ring tones and graphics associated with the digital media asset can also be purchased. Digital media assets can include single songs, complete albums, box sets, or compilations. Further, a song or other audio sample may have been featured in a television show or motion picture, and associated media assets might include one or more soundtrack albums or the actual television show or motion picture in which the song/audio sample was featured.

When referring to “purchase” of media items, namely, digital media assets, it is meant to correspond to the purchase of rights to the media items. These rights include ownership, license, usage, contractual or rental rights in or to the media items.

A portable media device is an electronic device that can be used to store and present media (e.g., audio). The recording may occur by using a microphone or by tuning into a wireless signal (e.g., AM FM radio, digital radio, or WiFi). The portable media device may have a built-in microphone or wireless tuner/network card, or may have the capability to accept accessories to add the necessary functionality. One example of a suitable portable media device is a digital media player (e.g., digital music player).

Media management applications (MMAs) operating on personal computers or media players, typically include software applications that typically incorporate the ability to do one or more of the following: play, browse, organize, purchase, and/or transfer digital media items between devices, including to portable media players (e.g., MP3 or MPEG4 players).

FIG. 1 is a block diagram of a media purchase system 100 according to one embodiment of the invention. The media purchase system 100 includes an on-line media commerce server 102. The on-line media commerce server 102 stores a plurality of digital media assets that are available for purchase via client devices via a network. In one implementation, the on-line media commerce server 102 is an on-line media store. As shown in FIG. 1, the media purchase system 100 includes a client device 104 and a portable media device 125. The client device 104 couples to a data network 106. Additionally, the on-line media commerce server 102 couples to the data network 106. In one implementation, the data network 106 can refer to high data-bandwidth networks, namely, wired networks, such as the Internet, Ethernet, gigabit Ethernet, and fiber optic, as well as wireless networks such as IEEE 802.11(a), (b) or (g) (WiFi), IEEE 802.16 (WiMax), and Ultra-Wide Band (UWB).

According to a first aspect of the invention, a user of the portable media device 125 obtains an audio sample, for instance, by recording an audio source 121 using a microphone 127 coupled to the portable media device. The audio sample may then be transferred to the client device 104 using a data cable or some other data transfer medium. A computer program 108, typically a media management application (MMA) or other media player application, which is running on the client device 104 can send the audio samples transferred from the portable media device 125 to a media identification server 114 via the data network 106. The media identification server 114 is capable of identifying the audio samples. For example, one or more songs that the user of the portable media device 125 has previously sampled can be identified at the identification server 114. Alternately, in another embodiment, the portable media device 125 can send the audio samples directly to the media identification server 114, either by a physical connection to the data network 106 (e.g., a network cable) or by using a wireless network (not shown). Once the identification server 114 receives the audio samples, the media identification server 114 communicates and/or coordinates with the client device 104 and/or the media commerce server 102 to enable the user of the client device 104 to purchase media assets (e.g., songs, videos, albums) associated with the identified audio sample. Subsequently, the client device 104 can download the purchased media assets from a media storage server 110, which is coupled to a media store 112, via the data network 106. As will be understood by those familiar with data networks, other network configurations are possible. Furthermore, while the media storage server 110, media identification server 114, and on-line media commerce server 102 are shown as individual and separate server computers, it will be understood by those familiar with the art that other configurations are possible. As one example, each server can be implemented such that it is distributed over multiple server computers. As another example, these various servers can be implemented by a single physical server computer.

In an alternate embodiment (not shown), the portable media device 125 connects directly to the data network 106 without the use of a client 104. According to this embodiment, the computer program 108 that is used to send the audio samples to the media identification server 114 resides on the portable media device 125.

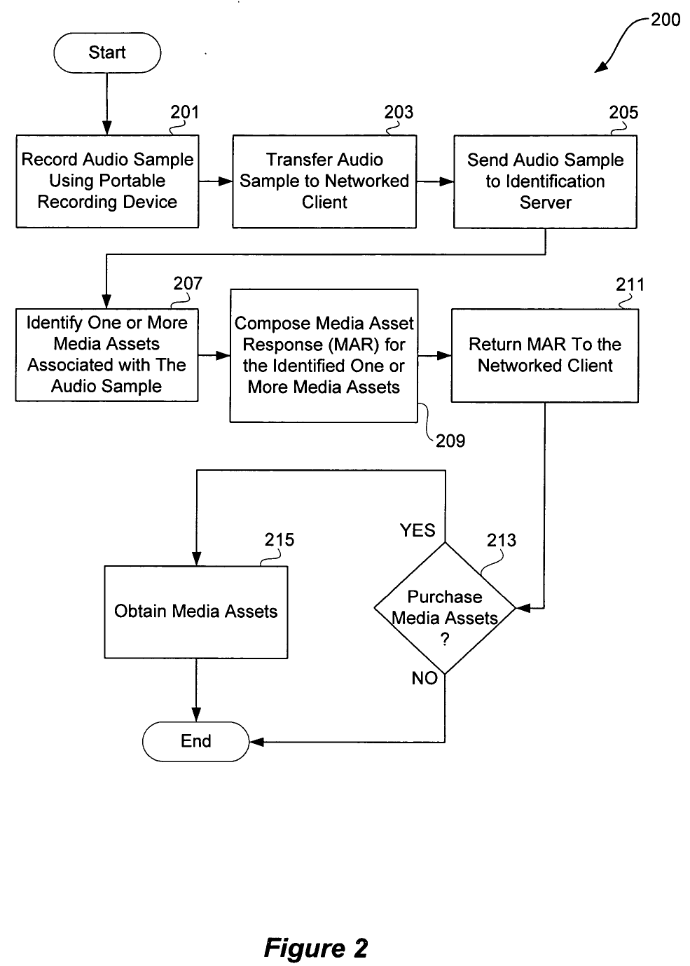

FIG. 2 is a flow diagram of an audio sample identification and purchase process 200 according to one embodiment of the invention. The audio sample identification and purchase process 200 is, for example, performed by an on-line media store and a media identification service interacting with a networked client, which in turn interacts with a portable media device. For example, referring to FIG. 1, the on-line media store can be the on-line media commerce server 102, the media identification service can be provided by the media identification server 114, the networked client can be the client device 104, and the portable media device can be the portable media device 125.

The audio sample identification and purchase process 200 begins with recording 201 of an audio sample using a portable media device. Following block 201, the audio sample is transferred 203 to a networked client (e.g., by a synchronization operation). Alternately, several audio samples can be recorded and transferred. Next, the networked client device sends 205 the sample to a media identification server. In one embodiment, sending 205 is accomplished using a media management application or media player. At the media identification server, one or more digital media assets associated with the audio sample are identified 207. The one or more identified digital media assets can include a wide variety of digital media asset types, including, but not limited to, music (songs, compilations, albums, soundtracks, etc.), music videos, motion pictures, electronic books (eBooks), and digital graphics.

Next, according to one embodiment of the invention, a media access response (MAR) is composed 209 (e.g., at a media commerce server linked to the media identification server). The MAR contains e-commerce information that will allow the recipient of the MAR to purchase one or more of the identified digital media assets. For example, the MAR can contain links to download the identified digital media assets or media previews (e.g., partial or low quality digital media assets) therefor, and/or links to a streaming audio media server associated with the identified digital media assets. Alternately, the MAR can contain information that enables a media management application or media player to interact with a user, for example, by using dialog boxes to ask a user for permission and/or authorization to buy and download the identified digital media assets. Following block 209, the MAR is sent 211 to the networked client.

Thereafter, decision 213 determines if the user wishes to purchase one or more of the identified digital media assets, for example, by some form of user interaction with a media management application. Alternately, the decision 213 can make the determination automatically without user interaction in accordance with a previously set user preference, for example, an “automatic buy” feature incorporated into a media management application. When the decision 213 determines that the user does not wish to purchase one or more of the identified digital media assets, the audio sample identification and purchase process 200 ends. On the other hand, if the decision 213 determines that the user wishes to purchase one or more of the identified digital media assets, the media assets are obtained 215 and the audio sample identification and purchase process 200 ends.

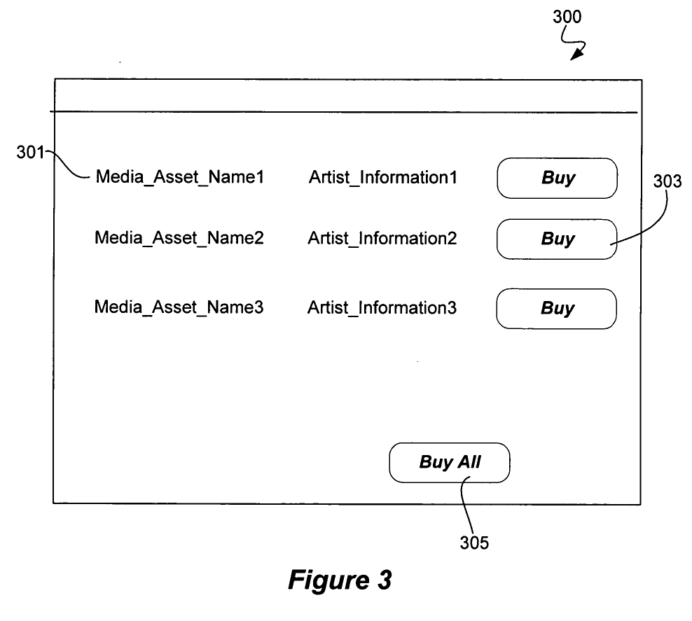

FIG. 3 is a diagram of an application program window 300 according to one embodiment of the invention. The application window 300 can be, for instance, provided by a media management application operating on a client device or a portable media player. An example of a media management application is iTunes® brand media management application, produced by and available from Apple Computer, Inc., of Cupertino, Calif.

According to one embodiment, the application program window 300 is displayed on a networked client, for example, the client device 104 in FIG. 1. Alternately, the application program window 300 can be displayed on a portable media device, for example, the portable media device 125 in FIG. 1. The application program window 300 contains one or more Graphical User Interface (GUI) elements, such as check boxes, text boxes, buttons, and hyperlinks. A user can interact with the GUI elements to browse digital media assets that are available on a remote server for purchase, download, or preview, including those which have been previously identified by, for example, the audio sample identification and purchase process 200 described illustrated in FIG. 2. The remote server can, for example, include one or both of the media commerce server 102 and the media storage server 110 shown in FIG. 1. Alternately, in another embodiment, the application program window 300 displays e-commerce information contained in a media access response (MAR), which is described above with reference to FIG. 2.

The application window 300 illustrated in FIG. 3 includes a list of digital media asset entries 301, each associated with a particular digital media asset. As an example, the digital media assets can be provided in a list. In one embodiment, the list includes metadata information (e.g., media asset title, publication information, author/artist/songwriter information, etc.). In the example shown in FIG. 3, the metadata information for each of the digital media asset entries 301 includes a media asset name and artist information. Additionally, the application window 300 contains buttons 303, each associated with one particular digital media asset entry 301. In the embodiment shown, buttons 303 are labeled “Buy”, indicating that the user may select (e.g., click on) a button 303 associated with a particular media asset entry 301 in order to purchase the media asset. Alternately, buttons 303 can have other functionality/labels, enabling a user to download and/or preview the listed media assets. Also shown is button 305, labeled “Buy All”, which allows a user to select (e.g., click on) a single button in order to purchase the digital media assets associated with all listed digital media asset entries 301. As is the case for buttons 303, button 305 can have other functionality/label, such as allowing a user to obtain previews or download multiple free promotional media assets, for example, a music artist sampler.

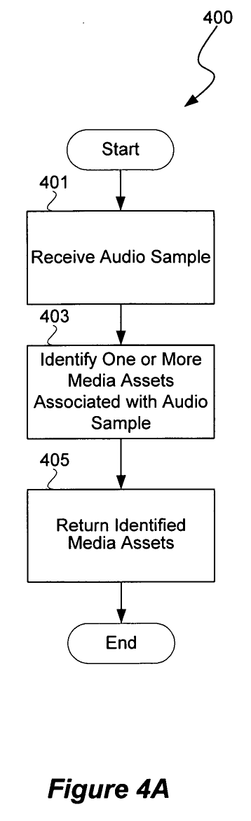

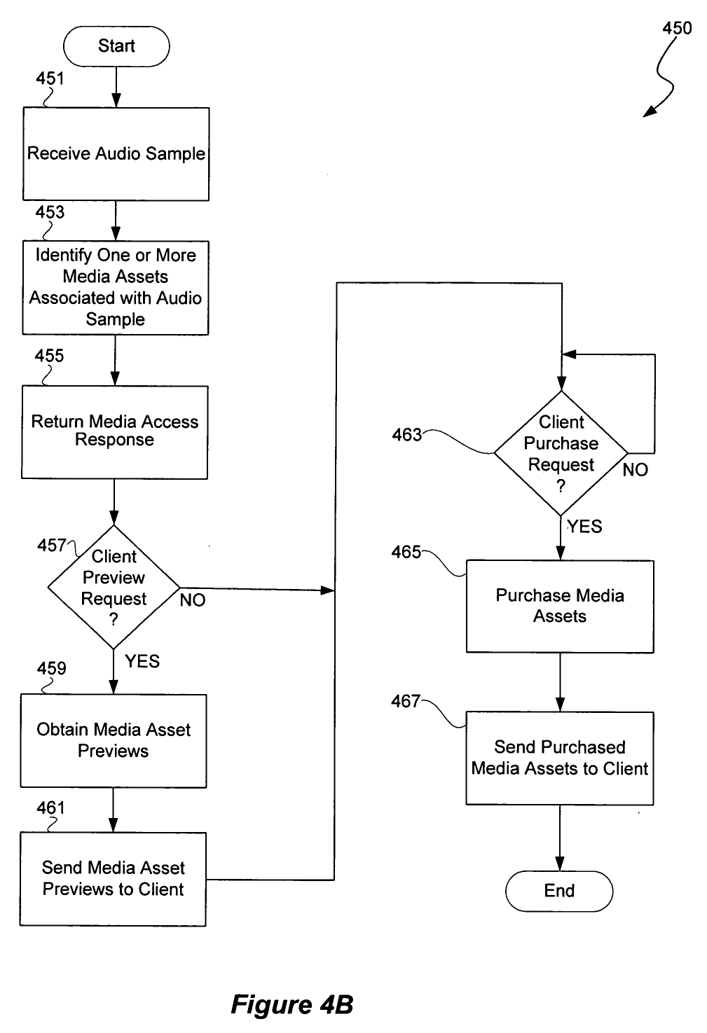

FIG. 4A is a flow diagram of a basic media identification process 400 according to one embodiment of the invention. The basic media identification process 400 is, for example, performed by the media identification server 114 of FIG. 1.

The basic media identification process 400 begins with receiving 401 an audio sample. The audio sample is received 401 from a client computer, for example, the client device 104 shown in FIG. 1. Next, one or more media assets associated with the received audio sample are identified 403. The identification of the received audio sample can use an appropriate audio (e.g., song) recognition algorithm. For an example of one algorithm suitable for use in identifying 403 audio samples, see U.S. Pat. No. 6,604,072, which is hereby incorporated by reference herein. Next, the one or more media assets are returned 405 (i.e., to the requesting client.). The returning 405 can include sending media assets directly to the requester. In other embodiments, the returning 405 can include sending a media access response (MAR) or deferred download instructions (see, for example U.S. patent application Ser. No. 10/833,267).

FIG. 4B is a flow diagram of a server side media identification and purchase process 450 according to another embodiment of the invention. This process is performed at a server computer. For example, the server computer can pertain to the media identification server 114, the media storage server 110, and the media commerce server 102 as shown in FIG. 1. In one embodiment, the server computer implements an on-line media store. The client, for example may be a client 104 (e.g., a personal computer connectable to the internet) running a media management application 108 as shown in FIG. 1.

The server side media identification and purchase process 450 begins with receiving 451 an audio sample at the server computer, for instance a media identification server. In general, the audio sample may be received at a server computer that has been setup to route received audio samples to another server computer which is setup to identify the audio sample. The received audio sample is then processed in order to identify 453 one or more media assets associated with the received audio sample. Here, in this embodiment, the one or more audio assets are songs. In one implementation, several versions associated with an audio sample of a song may be available-possibly by different artists or in different remixes.

Next, a media access response (MAR) is returned 455, for instance, to a requesting client computer. As discussed above with reference to FIG. 2, the MAR generally contains eCommerce information identifying media assets and enabling the recipient of the MAR to retrieve the media assets and/or previews of those assets and then access the media content (e.g., music, video) for the selected media assets. Following block 455, a decision 457 determines if a client has requested previews for one or more media assets. Alternately, the decision to preview the identified media assets may be set as a user preference (i.e., the user may decide in advance to always preview or never preview). Media asset previews can be, for example, short and/or low-quality snippets of available media assets. For a more information on media asset previews, see U.S. patent application Ser. No. 10/982,592 and U.S. Provisional Application No. 60/622,178. If the decision 457 determines that no preview request has been made, the server side media identification and purchase process 450 proceeds to a decision 463 and subsequent blocks. On the other hand, if the decision 457 determines that the request has been made, media asset previews are obtained 459 and then sent 461 to the client. Media asset previews can be obtained 459, for instance, by retrieving previews from a server computer or by creating previews as needed from available media assets. The sending 461 of the media asset previews can be accomplished, for example, by sending a link to the client that will allow the user to download or stream the media asset preview to the client.

The media identification and purchase process 450 continues with the decision 463, which determines if a client purchase request has been received for one or more media assets. If not, the decision 463 waits until a client purchase request has been received. Once the decision 463 determines that a client purchase request has been received, the desired media asset is purchased 465 and sent 467 to the client. Several embodiments of a method and system for network based purchase and distribution of media assets, for example, are discussed in U.S. patent application Ser. No. 10/833,267.

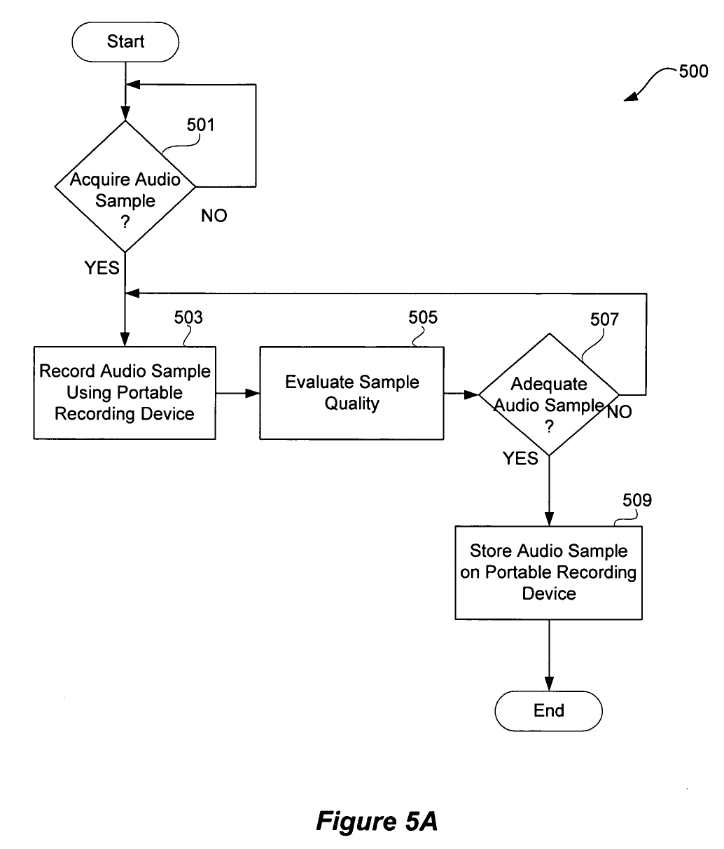

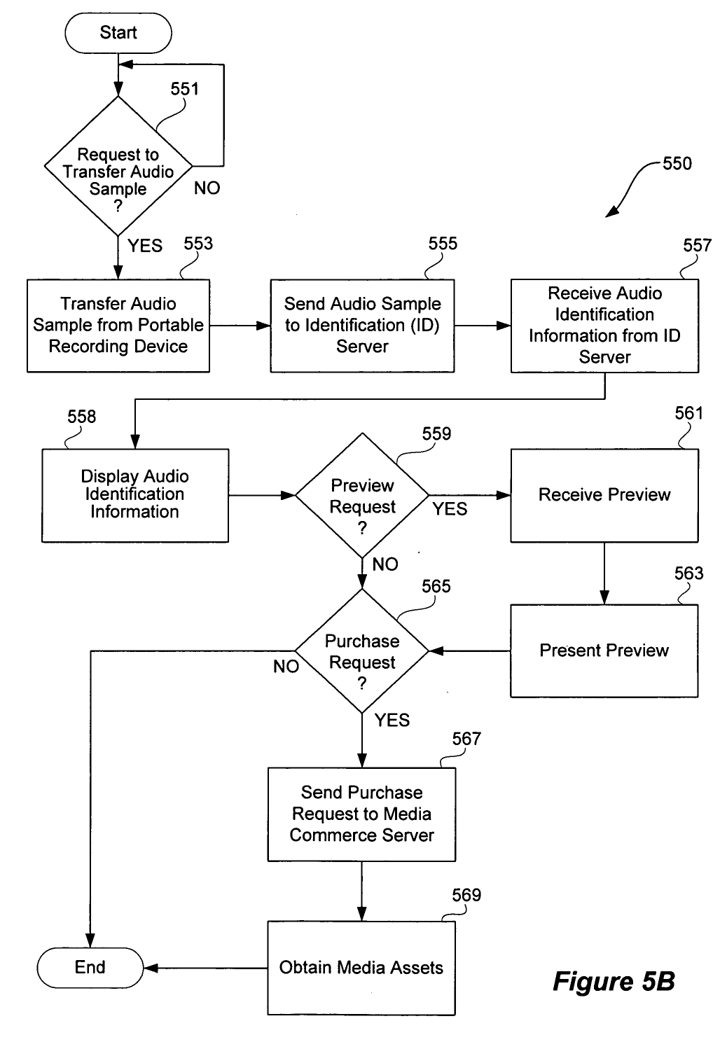

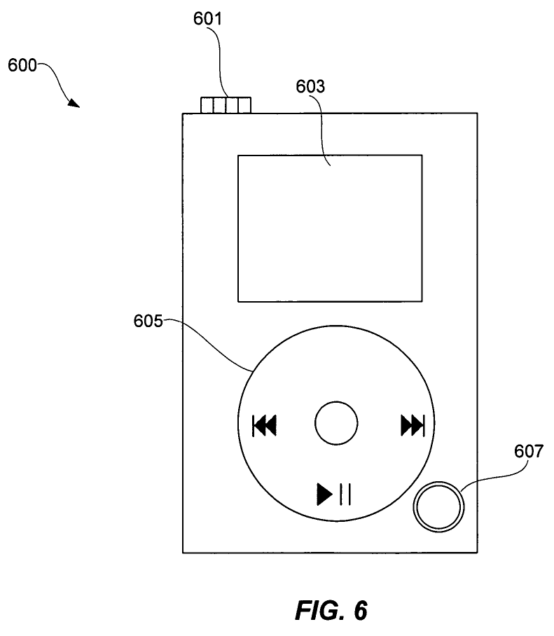

FIG. 5A is a block diagram of an audio sampling process 500 according to one embodiment of the invention. This process 500 is performed using, for example, a portable media device such as the portable media device 125 of FIG. 1 or the portable media device 600 of FIG. 6 discussed below. Generally, a portable media device suitable for use with this embodiment has the capability to transfer recordings to another device, such as a personal computer or server computer by, for example, a cable (e.g., USB or Firewire®) or by using wireless communication (e.g., Bluetooth, IR, or WiFi).

The audio sampling process 500 begins with a decision 501, which determines if an audio sample is to be acquired. Generally, an audio sample is taken when a user selects a record function on a portable media device. This selection can be, for example, via a button on the portable media device or via a menu selection. Alternately, a user can elect to set a user preference on a portable media device that instructs the portable media device to periodically make a recording without user input. In another embodiment, the audio sampling process maintains a sampling window. For example, the sampling window might be several minutes in length, such as five or ten minutes. Thus, if the user hears a song, but does not select the record function while it is still playing, the sample can still be stored if a sample window is being used. This allows a user the flexibility of listening to a song for some time, perhaps all the way through, before having to make a decision to record a sample.

If the decision 501 determines that an audio sample is to be acquired, an audio sample is recorded 503 using the portable media device. Recording can be accomplished using a microphone, or by tuning into a wireless signal (e.g., AM/FM radio, satellite radio, WiFi). Next, the quality of the audio sample is evaluated 505. Following evaluation 505, a decision 507 determines if the sample quality is sufficient for later identification of the sample. If so, the audio sample is stored 509 on the portable media device and the audio sampling process 500 ends. On the other hand, if decision 507 determines that the sample quality is insufficient for later identification of the sample, audio sampling process 500 returns to block 503 and subsequent blocks such that another or longer sample is taken to replace or supplement the low quality sample. Alternately, the portable media device may acquire a sample for a fixed period of time (e.g., 30 seconds) without evaluating 505 sample quality.

In the case where a user has set a user preference on the portable device to take periodic samples, the samples may be stored 509 for a short period of time, for example 24 hours. This prevents the accumulation of large amounts of recorded data in the portable media device's memory.

FIG. 5B is a block diagram of a client-side audio sample identification and purchase process 550 according to one embodiment of the invention. The client-side audio sample identification and purchase process 550 is performed, for example, using the portable media device 125 of FIG. 1 or the portable media device 600 of FIG. 6, coupled with a networked client device. The networked client 104 is, for example, the client 104 running the media management application 108 of FIG. 1. Generally, suitable client devices include personal computers and/or network appliances (e.g., WebTV, PlayStation®). Further, client devices are preferably connected to a computer network.

The client-side audio sample identification and purchase process 550 begins with a decision 551. The decision 551 waits for a request to transfer an audio sample from a portable media device. Upon determining that a request to transfer an audio sample has been made, the audio sample is transferred 553. As discussed above in reference to FIG. 5A, the transfer 553 of the audio sample can occur by a variety of mechanisms, such as by using a cable or wireless link. Next, the transferred audio sample is sent 555 to a media identification server, for example the media identification server 114 of FIG. 1. Next, audio identification information is received 557 from the media identification server and displayed 558 using, for example a media management application. The audio identification information can be, for example, the media access response (MAR) described above in reference to FIGS. 2 and 4B.

In one embodiment of the invention, where media asset previews are provided, optional blocks 559-563 can be performed. A decision 559 determines if a preview request has been made, for example, by clicking on a link displayed by a media management application. Next, a preview is received 561 and presented 563 to the user. Previews may be obtained, for instance, as described above in reference to FIG. 4B. Alternately, previews may be embedded in an MAR.

Next, a decision 565 determines if a purchase request has been made, for example by a user interacting with a media management application. If no request has been made, the client-side audio sample identification and purchase process 550 ends. Otherwise, if the decision 565 determines that a purchase request has been made, a purchase request is sent 567 to a media commerce server, for example the media commerce server 102 of FIG. 1. Next, purchased media assets are obtained 569, for example by downloading from the media store 112 of FIG. 1. Therefore, the client-side audio sample identification and purchase process 550 ends. It should be noted that any or all of the transfer request (decision 551), the preview request (decision 559) and the purchase request (decision 565) can be manually performed by a user or automatically performed without requiring user input.

In another embodiment of the invention, the portable media device is capable of connecting, either by wired (e.g., Ethernet) or wireless (e.g., cellular) connection, directly to the various identification and commerce servers, making it unnecessary to employ a networked client device as an intermediary. In such case, blocks 555-569 of the client-side audio sample identification and purchase process 550 can occur on the portable media device.

FIG. 6 shows an exemplary portable media device 600 suitable for use with the invention. The portable media device 600 includes an (optional) display 603, a control pad 605 containing one or more playback controls (e.g., play, rewind, fast forward, and/or pause), a microphone 601, and a microphone control. In this embodiment, the microphone control is a button 607. In another embodiment, the microphone control could be accessed using a menu system, rather than by using a button.

Another aspect of the invention pertains to a media tagging and acquisition system. As explained in more detail below, a portable media player can be coupled to a media system within a vehicle such that one or more digital media assets being presented by the media system can be tagged (flagged). After a digital media asset has been tagged, the portable media player can be removed from the vehicle environment and coupled to an electronic commerce environment. The electronic commerce environment facilitates the purchase of the digital asset that has been tagged. Although the media tagging according to this aspect of the invention is largely described with reference to a vehicle environment, it should be understood that the media tagging can also be used in other environments, such as a home entertainment environment.

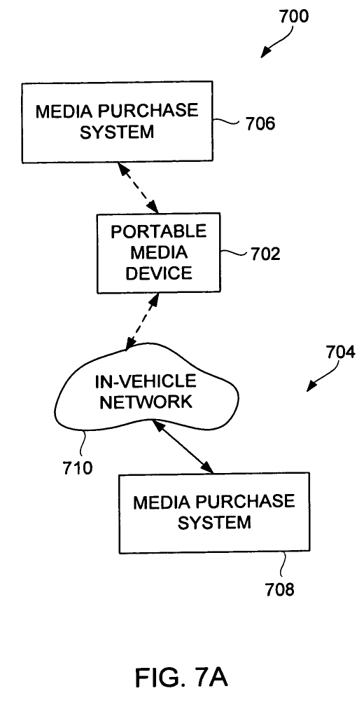

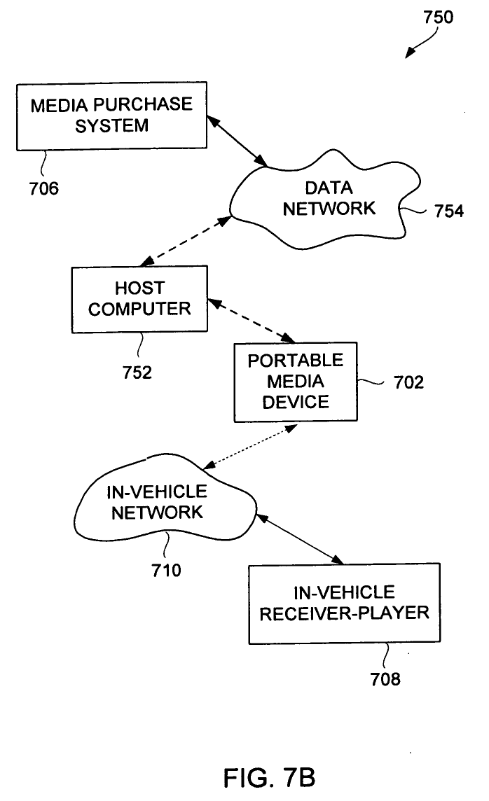

Embodiments of the invention are discussed below with reference to FIGS. 7A-12. However, those skilled in the art will readily appreciate that the detailed description given herein is for explanatory purposes as the invention extends beyond these limited embodiments.

FIG. 7A is a block diagram of a media tagging and acquisition system 700 according to one embodiment of the invention. The media tagging and acquisition system 700 is described with reference to a vehicle environment. The media tagging and acquisition system 700 includes a portable media device 702. The portable media device 702 is able to couple to an in-vehicle media system 704. The in-vehicle media system 704 includes an in-vehicle receiver-player 708 and an in-vehicle network 710. The in-vehicle receiver-player 708 also couples to the in-vehicle network 710. In addition, the portable media device 702 can couple to the in-vehicle network 710. As a result, the portable media device 702 can communicate with the in-vehicle receiver-player 708 via the in-vehicle network 710. In one embodiment, the in-vehicle network 710 has a connection port that is able to receive the portable media device 702 either directly or indirectly via a cable. As an example, the portable media player can be a digital media player.

When the portable media device 702 is connected to the in-vehicle network 710, the portable media device 702 has access to media information that is descriptive the media being played by the vehicle media system 704. For example, if the in-vehicle receiver-player 708 is playing audio content that is received from a radio frequency broadcast (e.g., AM, FM or XM), the portable media device 702 is able to determine descriptive media information associated with the audio content being played. The descriptive media information can vary with implementation or situation. In one implementation or situation, the descriptive media information includes a title, artist and/or album name for the audio content. In another implementation or situation, the descriptive information includes circumstantial information such when (e.g., time) the audio content was played and at least a radio frequency for a broadcasting station from which the media content being played originated. In any case, when the user of the portable media device 702 determines that they are interested in the particular media being played by the vehicle media system 704, the portable media device 702, through automatic or manual means, stores the descriptive media information.

After the descriptive media information has been acquired and stored, the portable media device 702 can be removed from the vehicle environment and used in the electronic commerce environment. Here, the portable media player 702 can connect to a media purchase system 706. The media purchase system 706 is typically an on-line commerce system. The portable media device 702 can couple to the media purchase system 706 in various different ways. For example, the portable media device 702 can couple to a host computer that in turn couples to the media purchase system 706. In another example, the portable media device 702 can couple to a kiosk which can be the media purchase system 706 or which in turn couples to the media purchase system 706. Regardless of how the portable media device 702 couples to the media purchase system 706, the descriptive information stored by the portable media device 702 can be provided to the media purchase system 706. The media purchase system 706 then facilitates purchase of a digital media asset that is associated with the descriptive media information.

In one implementation, the media purchase system 706 can be represented by the media commerce server 102 illustrated in FIG. 1. In another implementation, the media purchase system 706 can be represented by the media commerce server 102 together with one or both of the media storage server 110 and the media identification server 114, which are illustrated in FIG. 1.

In the embodiment illustrated in FIG. 7A, the portable media player is able to couple to and communicate over the in-vehicle network 710. However, in another embodiment, the portable media device 702 could couple to the in-vehicle receiver-player 708 without utilizing any in-vehicle network 710.

In another embodiment, the in-vehicle receiver-player 708 can is an in-vehicle receiver without any player capabilities (e.g., no ability to play CDs or MP3 files). In still another embodiment, the in-vehicle receiver-player 708 incorporates the functionality of the portable media device 702, at least as to the acquisition of descriptive media information. In such an embodiment, not only is the in-vehicle network 710 not utilized, but a separate portable media device 702 is also not needed. Instead, the in-vehicle receiver-player 708 acquires descriptive media information as appropriate and also interacts with the media purchase system 706 to facilitate purchase of a digital media asset that is associated with the descriptive media information. The in-vehicle receiver-player 708 can be either affixed to the vehicle or be removable therefrom.

FIG. 7B is a block diagram of a media tagging and acquisition system 750 according to another embodiment of the invention. The media tagging and acquisition system 750 has various components that are the same as those in the media tagging and acquisition system 700 illustrated in FIG. 7A. Additionally, however, the media tagging and acquisition system 750 includes a host computer 752 and a data network 754. The host computer 752 is, for example, a personal computer. The data network 754 can represent the Internet, a wide area network and/or a local area network. The data network 754 can be a wired network, a wireless network, or some combination thereof.

As shown in FIG. 7B, the portable media device 702 can couple to the host computer 752. For example, the portable media device 702 can couple to the host computer 752 by way of a peripheral bus (e.g., USB or Firewire®)). The host computer 752 can then communicate with the media purchase system 706 by way of the data network 754. Typically, the host computer 752 can operate a media management application that assists a user in acquiring and managing media, including media purchased from the media purchase system 706. In one implementation, the host computer 752 receives the descriptive media information from the portable media device 702. The host computer 752 can then interact with the media purchase system 706 to preview and/or purchase the digital media associated with the descriptive media information.

In the various embodiments of media tagging and acquisition systems noted above, coupling or communications between devices can be achieved in a wired or wireless manner. Wire connections typically offers greater data transmission rates, but wireless connections require less user interaction. For example, with reference to FIG. 7B, as a vehicle having the portable media device 702 is parked in a garage or driveway at one's home, the host computer 752 at the home can discover the portable media device 702 via a wireless network and thus establish a wireless connection, even automatically if desired.

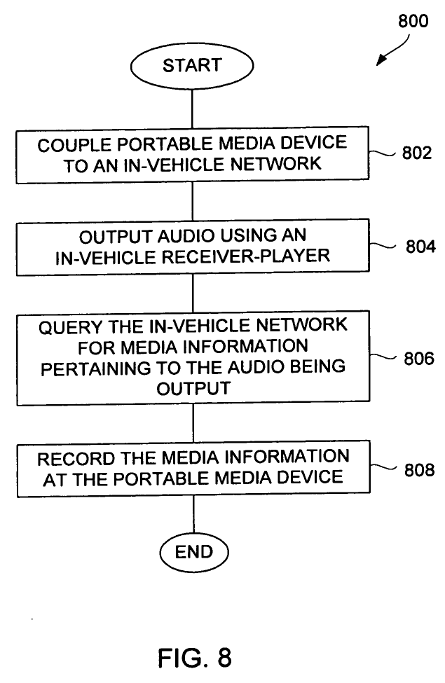

FIG. 8 is a media tagging process 800 according to one embodiment of the invention. The media tagging process 800 is associated with a vehicle environment that includes a media system (e.g., in-vehicle receiver-player) and an in-vehicle network.

The media tagging process 800 initially couples 802 a portable media device to the in-vehicle network. Here, the portable media device is not part of the vehicle environment. However, the portable media device can be removably coupled to the in-vehicle network. By coupling the portable media device to the in-vehicle network, the portable media device indirectly connects to the media system. As suggested above, the media system includes at least an in-vehicle receiver-player. The in-vehicle receiver-player outputs 804 audio for the vehicle environment. Thereafter, during or proximate to the audio output 804, the in-vehicle network can be queried 806 for media information pertaining to the audio being output. The media information that is received in response to the query can then be recorded 808 at the portable media device. Following the operation 808, the media tagging process 800 is ends with the tagging having been performed.

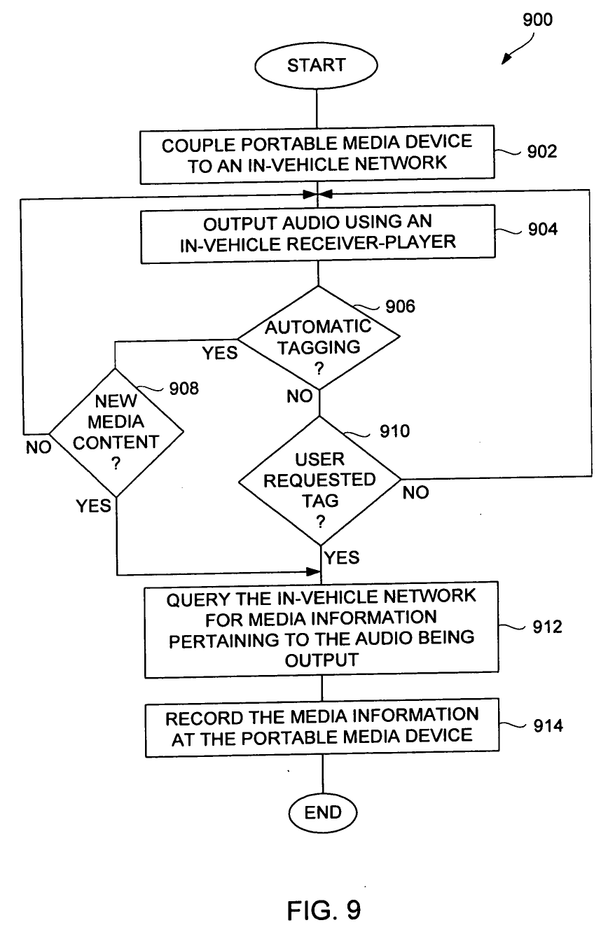

FIG. 9 is a flow diagram of a media content tagging process 900 according to another embodiment of the invention. The media content tagging process 900 is associated with a vehicle environment that includes a media system (e.g., in-vehicle receiver-player) and an in-vehicle network.

The media content tagging process 900 begins when a portable media device is coupled 902 to an in-vehicle network. Next, media content is output 904 using an in-vehicle receiver-player. A decision 906 then determines whether automatic tagging is to be performed. When the decision 906 determines that automatic tagging is to be performed, a decision 908 determines whether the media content being output 908 is new media content. For example, the media content is deemed new if the same media content has not already been output and tagged (i.e., not already tagged during this session). When the decision 908 determines that the media content being output is new media content, then processing can continue to tag the media content. Alternatively, when the decision 908 determines that the media content being output is not new media content, then the media content tagging process 900 returns to repeat the block 904 and subsequent blocks.

On the other hand, when the decision 906 determines that automatic tagging is not being utilized, then a decision 910 determines whether a user has requested to tag the media content being output. When the decision 910 determines that the user is not requesting to tag the audio content, then the media content tagging process 900 returns to repeat the block 904 and subsequent blocks.

Alternatively, when the decision 910 determines that the user is requesting to tag the audio content, or when the decision 908 determines that the media content being output is new media content, then the media content tagging process 900 proceeds to tag the media content being output (e.g., played). In particular, tagging the media content involves querying 912 the in-vehicle network for media information pertaining to the media content being output. Then, the media information can be recorded 914 at the portable media device. Following the block 914, then media content tagging process 900 is complete and ends.

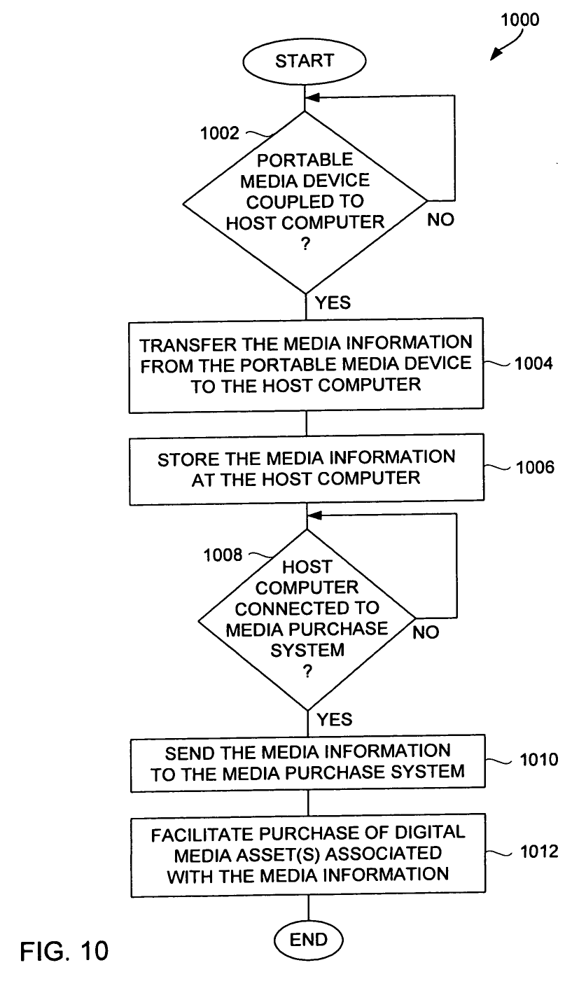

FIG. 10 is a flow diagram of a media information transfer process 1000 according to one embodiment of the invention. The media information transfer process 1000 begins with a decision 1002. The decision 1002 determines whether a portable media device is coupled to a host computer. As previously noted, a portable media device can be coupled to a host computer, such as through use of a peripheral cable or a wireless connection. When the decision 1002 determines that the portable media device is not coupled to the host computer, then the media information transfer process 1000 awaits such coupling. On the other hand, once the decision 1002 determines that the portable media device is coupled to the host computer, the media information transfer process 1000 effectively begins. In one implementation, the media information transfer process 1000

Once the media information transfer process 1000 proceeds, the media information from the portable media device is transferred 1004 to the host computer. In one implementation, the media information can be automatically transferred 1004, such as part of a synchronization process. In another implementation, the media information can be transferred 1004 in response to a user request (i.e., a manual user action). Regardless, once the media information is transferred 1004, the media information is stored 1006 at the host computer.

Once the media information is stored 1006 at the host computer, a user of the host computer can view or edit the media information. For example, the media information can be displayed at the host computer for the user's viewing. The user might choose to delete the media information when the user no longer desires to purchase any associated digital media assets.

Next, a decision 1008 determines whether the host computer is connected to a media purchase system. The connection can be implemented as a wired connection or a wireless connection. When the decision 1008 determines that the host computer is not connected to the media purchase system, the media information transfer process 1000 awaits such a connection. At this point, it is no longer necessary for the portable media device to be coupled to the host computer. However, the host computer does need a connection to the media purchase system. Hence, the subsequent processing of the media information transfer process 1000 can be deferred until the host computer subsequently connects to the media purchase system.

In any event, once the decision 1008 determines that the host computer is connected to the media purchase system, the media information can be sent 1010 from the host computer to the media purchase system. Here, it should be noted that the media information being sent 1010 to the media purchase system can be the same media information that was transferred to the host computer from the portable media device. However, it should be equally understood that the media information can be different then the media information received from the portable media device, such as in the information could be processed, formulated or otherwise altered for purposes of use with the media purchase system. Next, the media information transfer process 1000 facilitates 1012 purchase of one or more of digital media assets associated with the media information. Following the block 1012, the media information transfer process 1000 is complete and ends.

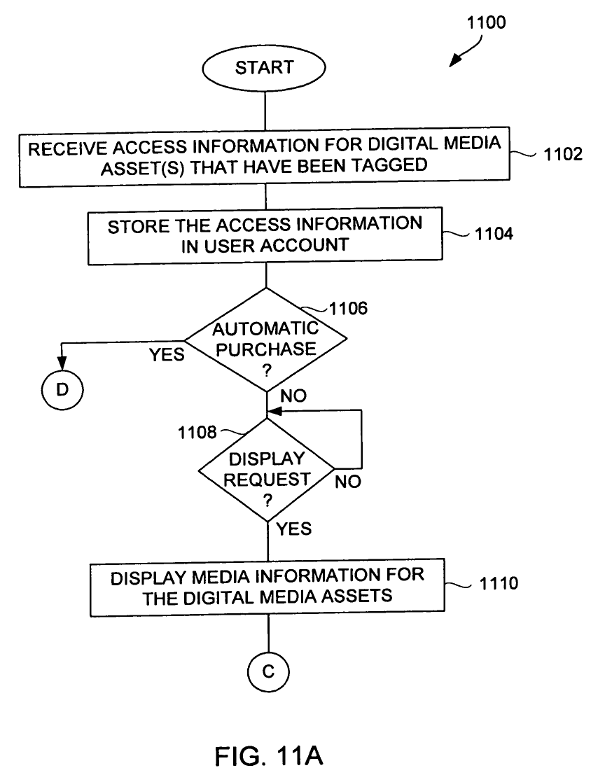

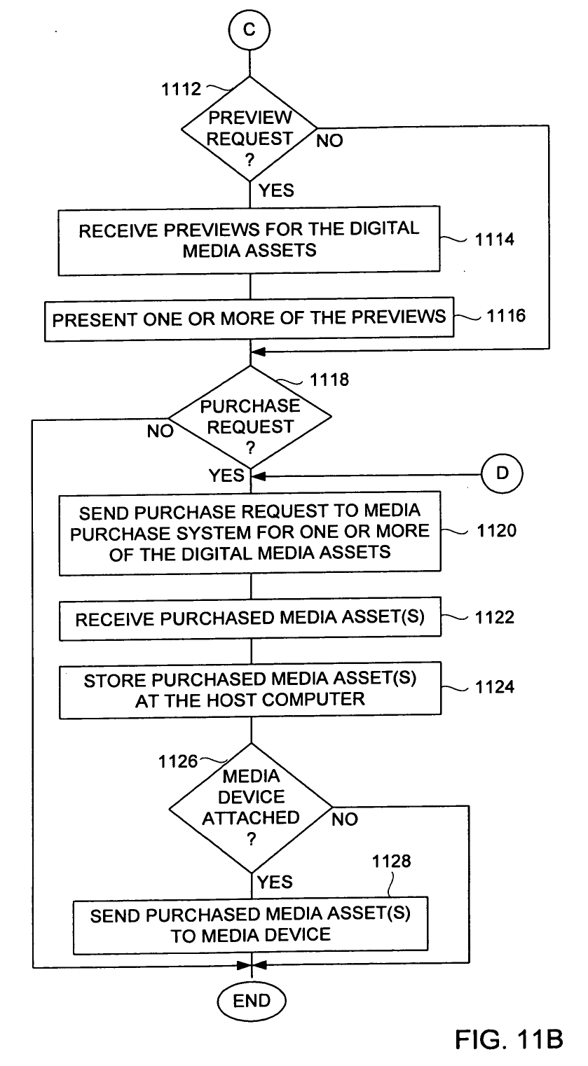

FIGS. 11A and 11B are flow diagrams of a purchase process 1100 according to one embodiment of the invention. The purchase process 1100 is, for example, performed by a host computer One example of a host computer is the host computer 752 illustrated in FIG. 7B. Some of the purchase process 1100 involves interaction between the host computer and a media purchase system (e.g., the media purchase system 706 illustrated in FIG. 7B).

The purchase process 1100 initially receives 1102 access information for one or more digital media assets that have been tagged. The access information is used to acquire media content associated with the one or more of digital media assets that then tagged. The access information is stored 1104 in a user account. In other words, the access information pertaining to the one or more digital media assets that have been tagged are now stored on the host computer in a manner associated with a user account. Hence, when an appropriate user is operating the host computer, the user is able to access the user account and make use of the access information.

Next, a decision 1106 determines whether an automatic purchase feature is enabled. When the decision 1106 determines that the automatic purchase feature is not enabled, a decision 1108 determines whether a display request has been made. When the decision 1108 determines that a display request has not been made, the purchase process 1100 awaits such a request. Once the decision 1108 determines that a display request has been received, the media information for the one or more digital media assets is displayed 1110.

Next, a decision 1112 determines whether a preview request has been received. When the decision 1112 determines that a preview request has been received, previews for the one or more digital media assets are received 1114. Then, one or more of the previews are presented 1116. For example, the previews can be presented 1116 by playing the previews at the host computer. Alternatively, when the decision 1112 determines that a preview request has not been received, the operations 1114 and 1116 are bypassed.

Following the operation 1116, or its being bypassed, a decision 1118 determines whether a purchase request has been received. When the decision 1118 determines that a purchase request has been received, a purchase request is sent 1120 to the media purchase system for purchase of one or more on the digital media assets. In response to the purchase request to the media purchase system, the one or more purchased media assets are then received 1122 at the host computer. The one or more purchased media assets are then stored 1124 at the host computer. A decision 1126 then determines whether the portable media device is attached to the host computer. When the decision 1126 determines that the media device is attached to the host computer, the one or more purchased media assets can be sent 1128 to the media device. In other words, the one or more media assets that have been purchased at the host computer can be downloaded to the media device, assuming the media device is attached (or wirelessly available). Alternatively, when the decision 1126 determines that the media device is not attached, the operation 1128 is bypassed so that the purchased media assets are not sent to the media device at such time. For example, during a later connection of the media device to the host computer, the purchased media assets can be sent 1128 to the media device. In one implementation, the purchased media assets can be sent 1128 to the media device during a synchronization process between the host computer and the media device.

Still further, when the decision 1106 determines that automatic purchase is enabled, then the purchase process 1100 proceeds to automatically purchase the one or more digital media assets by proceeding to perform the operation 1120 and subsequent operations. In such case, the one or more of the digital media assets can be purchased, received and stored without requiring any user input. The purchased media assets can be provided to a media device without requiring any user input. Hence, in certain implementations, the purchase process 1100 can be substantially or fully automated.

On the other hand, when the decision 1118 determines that a purchase request has not been made, the operations 1120-1128 are bypassed. Also, following the block 1128, or its being bypassed, the purchase process 1100 is complete and ends.

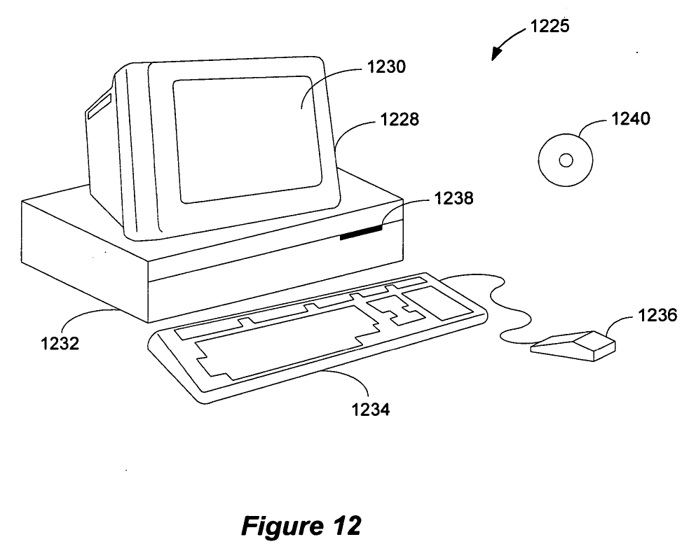

FIG. 12 shows an exemplary computer system 1225 suitable for use with the invention. Computer system 1225 includes a display monitor 1228 having a single or multi-screen display 1230 (or multiple displays), cabinet 1232, keyboard 1234, and mouse 1236. Cabinet 1232 houses a drive 1238, such as a CD-ROM or floppy drive, system memory and a hard drive (not shown) which may be utilized to store and retrieve software programs incorporating computer code that implements the present invention, data for use with the invention, and the like. Although CD-ROM 1240 is shown as an exemplary computer readable storage medium, other computer readable storage media including floppy disk, tape, flash memory, system memory, and hard drive may be utilized. Additionally, a data signal embodied in a carrier wave (e.g., in a network including the Internet) may be the computer readable storage medium. In one implementation, an operating system for the computer system 1225 is provided in the system memory, the hard drive, the CD-ROM 1240 or other computer readable storage medium and serves to incorporate the computer code that implements the invention.

Although a portable media device typically includes the capabilities to store and present media (e.g., audio), other devices can be used in place of the portable media device discussed above, so long as the devices include the required functionality for the implementations. As an example, one such other device can be referred to as a recording device since one of its significant functions is to record an audio sample.

Although the media assets (or media items) of emphasis in several of the above embodiments were audio items (e.g., audio files or audio tracks), the media assets are not limited to audio items. For example, the media assets can alternatively pertain to videos (e.g., movies) or images (e.g., photos). Also, in one implementation, the audio files or audio tracks can pertain to songs or audiobooks.

The various aspects, embodiments, implementations or features of the invention can be used separately or in any combination.

The invention can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that users of portable media device can identify media items of interest with minimal effort and then have a media management application inform the user of the identified media items. Another advantage of the invention is that electronic commerce as well as electronic delivery for identified media items (and/or other associated items) can be conveniently provided, even substantially or fully automated if desired.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for facilitating e-commerce, comprising:
(a) recording an audio sample using a portable media device;
(b) subsequently transferring the audio sample from the portable media device to a networked client device;
(c) identifying one or more media assets associated with the audio sample; and
(d) obtaining, at the networked client device, the one or more identified media assets.

2. A method of claim 1, wherein said purchasing (d) is automatic.

3. A method of claim 1, wherein said identifying (c) is performed at a media identification server, and
wherein said identifying (c) comprises sending the audio sample to the media identification server.

4. A method of claim 3, wherein said identifying (c) further comprises: receiving, the networked client device, media identification information from a media identification server.

5. A method of claim 3, wherein said method further comprises:
(e) facilitating the purchase of at least one of the one or more identified media assets.

6. A method of claim 5, wherein said facilitating (e) of the purchase comprises:
(e1) sending e-commerce information regarding the one or more identified media assets to the networked client device; and
(e2) using the networked client device to purchase at least one of the identified media assets based on the e-commerce information.

7. A method of claim 5, wherein said facilitating (e) of the purchase is done using a media management application operating on the networked client device.

8. A method of claim 7, wherein the media management application interacts with an on-line media store to complete said facilitating (e) of the purchase.

9. A method of claim 1, wherein said transferring (b) is performed during a synchronization operation between the portable media device and the networked client device.

10. A method of claim 1, wherein said recording (a) records the audio sample by analog sampling via a microphone.

11. A method of claim 1, wherein said recording (a) records the audio sample by digitally sampling a wireless signal.

12. A method of claim 1, wherein the portable media device is a portable media player.

13. A method of claim 12, wherein the networked client device is a personal computer capable of connecting to the Internet.

14. A method of claim 1, wherein the one or more identified media assets are selected from a list consisting of: a music single, a music album, a music video, a motion picture, and an e-book.

15. A method for facilitating e-commerce, comprising:
receiving, at a server computer, an audio sample from a client computer;
identifying at least media asset associated with the audio sample;
receiving a request to purchase the identified media asset;
processing a payment for purchase of the requested media asset; and,
delivering the requested media asset to the client computer.

16. A method of claim 15, said method further comprises:
returning a media asset information response to the client computer after said identifying.

17. A method of claim 16, wherein the media asset information response comprises e-commerce information which may be used to purchase the one or more identified media asset.

18. A method of claim 15, wherein said processing further comprises authorizing the request to purchase.

19. A method of claim 15, wherein the server computer is, or connects to, a music identification server.

20. A method of claim 15, where in the client computer is a personal computer capable of connecting to the Internet.

21. A method of claim 15, wherein the request to purchase is an automatic operation without any need for user input.

22. A method of claim 15, wherein the identified media asset is selected from a list consisting of: a music single, a music album, a music video, a motion picture, and an e-book.

23. A method of claim 15, wherein said method further comprises:
receiving a request for a media asset preview from the client computer;
obtaining the media asset preview; and
sending the media asset preview to the client computer.

24. A method of claim 23, wherein the media asset preview comprises e-commerce information that enables a user of the networked client device to purchase a complete digital media item corresponding to the media asset preview.

25. A method of claim 24, wherein the media asset preview is nontransferable.

26. A method of claim 23, wherein said sending of the media asset preview comprises streaming the media asset preview to the client computer.

27. A method for facilitating e-commerce, comprising:
(a) recording an audio sample using a portable media player;
(b) transferring the audio sample from the portable media player to a networked client device;
(c) receiving, from the networked client device, media information identifying one or more media assets associated with the audio sample;
(d) purchasing, at the networked client device, the one or more media assets identified by the media information; and
(e) obtaining, at the networked client device, the media assets that have been purchased.

28. A method of claim 27, wherein said recording (a) is an automatic operation without any need for user input.

29. A method of claim 27, wherein said recording (a) continuously records via a sampling window.

30. A method of claim 27, wherein the media information includes e-commerce information.

31. A method of claim 27, wherein said purchasing (d) is performed using a media management application running on the networked client device.

32. A method of claim 31, wherein the media management application interacts with an on-line media store to complete said purchasing (d).

33. A method of claim 27, wherein said transferring (b) is performed during a synchronization operation between the portable recording device and the networked client device.

34. A method of claim 27, wherein said recording (a) records the audio sample by analog sampling via a microphone.

35. A method of claim 27, wherein said recording (a) records the audio sample by digitally sampling a wireless signal.

36. A method of claim 27, wherein the networked client device is a personal computer connected to the Internet.

37. A method of claim 27, wherein said recording (a) comprises:
(a1) evaluating audio quality of the audio sample; and
(a2) determining how long to continue recording based on the audio quality.

38. A method of claim 27, wherein the purchasing (d) comprises:
(d1) requesting one or more media asset previews, wherein one or more links to the media asset previews are contained in the media information response;
(d2) receiving the one or more media asset previews; and
(d3) purchasing one or more media assets associated with the one or more media asset previews.

39. A method of claim 38,
wherein the media information includes e-commerce information, and
wherein the e-commerce information enables a user of the networked client device to purchase one or more complete digital media assets corresponding to the one or more media asset previews.

40. A method of claim 38, wherein the one or more media asset previews are partial digital music files.

41. A method of claim 38, wherein the media asset previews are nontransferable.

42. A method of claim 38, wherein said receiving (d2) of the media asset previews is performed by streaming to the networked client device.

43. A method for facilitating e-commerce, comprising:
(a) recording an audio sample using a portable media device;
(b) identifying one or more media assets associated with the audio sample; and
(c) obtaining, at the portable media device, the one or more identified media assets.

44. A method of claim 43, wherein said obtaining (c) is automatic.

45. A method of claim 44, wherein said identifying (b) is performed at a media identification server, and
wherein said identifying (b) comprises sending the audio sample to the media identification server.

46. A method of claim 45, wherein said method further comprises:
(d) facilitating purchase of at least one of the one or more identified media assets.

47. A method of claim 46, wherein said facilitating (d) of the purchase comprises:
(d1) sending e-commerce information regarding the one or more identified media assets to the portable media device; and
(d2) using the portable media device to purchase at least one of the identified media assets based on the e-commerce information.

48. A computer readable medium including at least computer program code for facilitating e-commerce, said computer readable medium comprising:
computer program code for storing a media indicia at a portable media device, the media indicia being associated with a digital media asset of interest to a user of the portable media device;
computer program code for subsequently transferring the media indicia from the portable media device to a networked client device;
computer program code for identifying at least one digital media asset associated with the audio sample based on the media indicia; and
computer program code for obtaining, at the networked client device, the at least one identified digital media assets from a remote server via a network.

49. A computer readable medium as recited in claim 48, wherein the media indicia is associated with a digital media asset that the user of the portable media device designated as being of interest.

50. A method for facilitating on-line purchase of media related items, said method comprising:
coupling a portable media device to an in-vehicle network having an in-vehicle media receiver-player coupled thereto;
outputting media using the in-vehicle media receiver-player;
querying the in-vehicle network for descriptive media information pertaining to the media being output; and
storing the descriptive media information at the portable media device.

51. A method as recited in claim 50, wherein said method further comprises:
interacting with the portable media player to indicate interest in the media output from the in-vehicle media receiver-player.

52. A method as recited in claim 51, wherein said querying is performed after said interacting indicates that the media output is of interest.

53. A method as recited in claim 52, wherein said method further comprises:
thereafter facilitating purchase of a product associated with the media output of interest using the stored descriptive media information.

54. A method as recited in claim 50, wherein said method further comprises:
thereafter facilitating purchase of a product associated with the media output using the stored descriptive media information.

55. A method as recited in claim 54, wherein the product being purchased is a digital media asset provided in an electronic file.

56. A method as recited in claim 55, wherein said facilitating purchase of a product comprises:
sending the stored descriptive media information to an on-line commerce system.

57. A method as recited in claim 56, wherein said facilitating purchase of a product further comprises:
receiving, from the on-line commerce system, the product associated with the media output.

58. A method as recited in claim 50, wherein the media being output is audio.

59. A method for facilitating on-line purchase of products, said method comprising:
(a) perceiving, by a user, information about a product;
(b) interacting with a portable media device to signal an interest in the product;
(c) capturing digital data associated with the product using a wireless receiver, the digital data being receivable at the vicinity of where the user perceived the product; and
(d) subsequently forwarding the digital data to an electronic commerce engine to facilitate purchase of the product or a related product.

60. A method for facilitating on-line purchase of products, said method comprising:
(a) receiving, at a portable media device, a signal from a user indicating an interest in a product being perceived by the user;
(b) capturing digital data associated with the product using a wireless receiver, the digital data being receivable at the vicinity of where the user perceived the product; and
(c) subsequently forwarding the digital data to an electronic commerce engine to facilitate purchase of the product or a related product.

61. A method as recited in claim 60, wherein the signal that is received is received proximate in time to the perceiving of the product by the user.
